(19) United States
(12) Patent Application Publication
(10) Pub. No.: US 2023/0053716 A1
(43) Pub. Date: Feb. 23, 2023

(54) SYSTEM AND METHOD OF SEMI-SUPERVISED LEARNING WITH FEW LABELED IMAGES PER CLASS

(71) Applicant: Naver Corporation, Seongnam-si (KR)

(72) Inventors: Philippe Weinzaepfel, Montbonnot-Saint-Martin (FR); Gregory Rogez, Meylan (FR); Thomas Lucas, Meylan (FR)

(73) Assignee: Naver Corporation, Seongnam-si (KR)

(21) Appl. No.: 17/708,214

(22) Filed: Mar. 30, 2022

Related U.S. Application Data
(60) Provisional application No. 63/230,898, filed on Aug. 9, 2021.
(60) Provisional application No. 63/290,233, filed on Dec. 16, 2021.

(51) Int. Cl. G06N 3/08; G06N 3/04; G06K 9/62

(52) U.S. Cl. CPC G06N 3/08; G06N 3/04; G06K 9/6218; G06K 9/6259

(57) ABSTRACT

A method of semi-supervised learning includes inputting an image; generating a weak augmentation version and a strong augmentation version of the inputted image; predicting a class of the weak augmentation version of the inputted image; determining if the predicted class of the weak augmentation version of the inputted image is confident; using a pseudo-label to train a model using the strong augmentation version of the inputted image when the predicted class of the weak augmentation version of the selected image is confident; and using a self-supervised loss based on deep clustering to train a model using the strong augmentation version of the selected image when the predicted class of the weak augmentation version of the selected image is not confident.

### PRIORITY INFORMATION

The present application claims priority, under 35 USC § 119(e), from US Provisional Patent Application, Ser. No. 63/230,898, filed on Aug. 9, 2021. The entire content of US Provisional Patent Application, Ser. No. 63/230,898, filed on Aug. 9, 2021, is hereby incorporated by reference.

The present application claims priority, under 35 USC § 119(e), from US Provisional Patent Application, Ser. No. 63/290,233, filed on Dec. 16, 2021. The entire content of US Provisional Patent Application, Ser. No. 63/290,233, filed on Dec. 16, 2021, is hereby incorporated by reference.

### BACKGROUND

While early deep learning methods have performed in fully-supervised settings, a recent trend is to focus on reducing the need for labeled data. On the other hand, self-supervised models learn without any labels; in particular, works, based on the paradigm of contrastive learning learn features that are invariant to class-preserving augmentations and have shown transfer performance that may surpass that of models pre-trained on ImageNet with label supervision.

In practice, however, labels are still required for the transfer to the final task. Semi-supervised learning aims to reduce the need for labeled data in the final task, by leveraging both a small set of labeled samples and a larger set of unlabeled samples from the target classes.

One conventional example, the FixMatch approach, unifies two trends in semi-supervised learning: pseudo-labeling and consistency regularization

Pseudo-labeling, also referred to as self-training, consists of accepting confident model predictions as targets for previously unlabeled images, as if the confident model predictions were true labels.

Consistency regularization methods obtain training signal using a modified version of an input; e.g., using another augmentation, or a modified version of the model being trained.

In Fix-Match, a weakly-augmented version of an unlabeled image is used to obtain a pseudo-label as a distillation target for a strongly-augmented version of the same image. In practice, the pseudo-label is only set if the prediction is confident enough, as measured by the peakiness of the softmax predictions. If no confident prediction can be made, no loss is applied to the image sample. FixMatch obtains semi-supervised results and demonstrates performance in barely-supervised learning close to fully-supervised methods on CIFAR-10. However, it does not perform as well with more realistic images; e.g., on the STL-10 dataset when the set of labeled images is small.

In FixMatch, the choice of confidence threshold, beyond which a prediction is accepted as pseudo-label, has a high impact on performance. A high threshold leads to pseudo-labels that are more likely to be correct, but also leads to fewer unlabeled images being considered. Thus, in practice a smaller subset of the unlabeled data receives training signal, and the model may not be able to make high quality predictions outside of it.

If the threshold is set too low, many images will receive pseudo-labels but with the risk of using wrong labels, which may then propagate to other images, a problem known as confirmation bias

In other words, FixMatch faces a distillation dilemma between allowing more exploration but with possibly noisy labels, or exploring fewer images with more chances to have correct pseudo-labels.

For barely-supervised learning, a possibility is to leverage a self-then-semi paradigm; i.e., to first train a model with self-supervision in order to initialize the semi-supervised learning phase, as proposed in SelfMatch. However, this might not be optimal as the self-supervision step ignores the availability of labels for some images. Empirically, such models tend to output overconfident pseudo-labels in early training, including for incorrect predictions.

Accordingly, it is desirable to provide a learning method that does not fail in barely-supervised scenarios, due to a lack of training signal when no pseudo-label can be predicted with high confidence.

It is also desirable to leverage self-supervised methods to provide training signal in the absence of confident pseudo-labels.

It is further desirable to effectively combine self-supervised and semi-supervised strategies in a unified formulation to provide training signal in the absence of confident pseudo-labels.

Moreover, it is further desirable to effectively combine self-supervised and semi-supervised strategies in a unified formulation to provide a self-supervision signal in cases where no pseudo-label can be assigned with high confidence.

### BRIEF DESCRIPTION OF THE DRAWINGS

The drawings are only for purposes of illustrating various embodiments and are not to be construed as limiting, wherein:

FIG. 1 illustrates an example of architecture in which the disclosed methods may be performed;

FIG. 2 illustrates an example of architecture for a method of learning/training a model using combine self-supervised and semi-supervised strategies;

FIGS. 3 and 4 illustrate a flowchart showing an example of a method of learning/training a model using combine self-supervised and semi-supervised strategies;

FIG. 5 illustrates a graphical representation of the distillation dilemma of FixMatch;

FIG. 6 illustrates a graphical representation of the classification accuracy on STL-10 for various sizes of labeled sets;

FIG. 7 illustrates a graphical representation of the evolution of the pseudo-labels during training;

FIG. 8 illustrates a graphical representation of the results on STL-10 for various sizes of labeled set;

FIG. 9 is a table showing ablation on the threshold parameter τ on the STL-10 dataset for 40 and 80 labeled images;

FIG. 10 is a table showing of the comparison between the LESS approach and FixMatch for barely-supervised learning on CIFAR-100 and CIFAR-10; and

FIG. 11 is a table showing the comparison of various conventional approaches on CIFAR.

### DETAILED DESCRIPTION

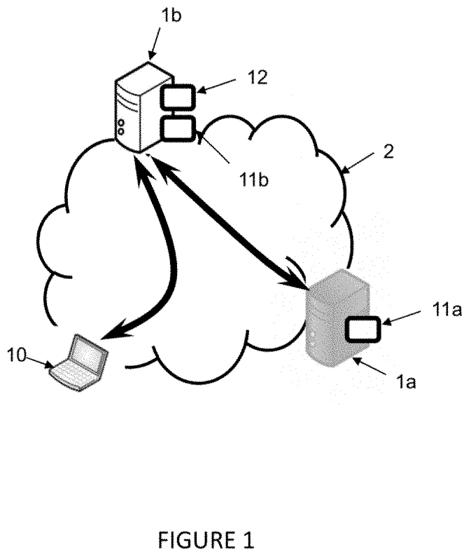

The methods described below are implemented within an architecture such as illustrated in FIG. 1, by means of a first and/or second server 1a, 1b. The first server 1a is the learning server (implementing the first method) and the second server 1b is a person re-identification server (implementing the second method). It is fully possible that these two servers may be merged.

Each of these servers 1a, 1b is typically remote computer equipment connected to an extended network 2 such as the Internet for data exchange. Each server 1a, 1b comprises data processing means 11a, 11b and optionally storage means 12 such as a computer memory; e.g., a hard disk.

The memory 12 of the first server 1a stores a training database; i.e., a set of already identified data (as opposed to so—called inputted data that precisely is sought to be identified).

The architecture comprises one or more items of client equipment 10, which may be any workstation (also connected to network 2), preferably separate from the servers 1a, 1b but possibly being merged with one and/or the other thereof. The client equipment 10 has one or more data items to be identified. The operators of the equipment are typically “clients” in the commercial meaning of the term, of the service provider operating the first and/or second servers 1a, 1b.

The following describes a method and system for semi-supervised learning when the set of labeled samples is limited to a small number of images per class; e.g., less than ten images per class. Moreover, the below described method and system provide training signal in the absence of confident pseudo-labels.

Additionally, the following describes two methods to refine the pseudo-label selection process. The first method relies on a per-sample history of the model predictions, akin to a voting scheme. The second method iteratively updates class-dependent confidence thresholds to better explore classes that are under-represented in the pseudo-labels.

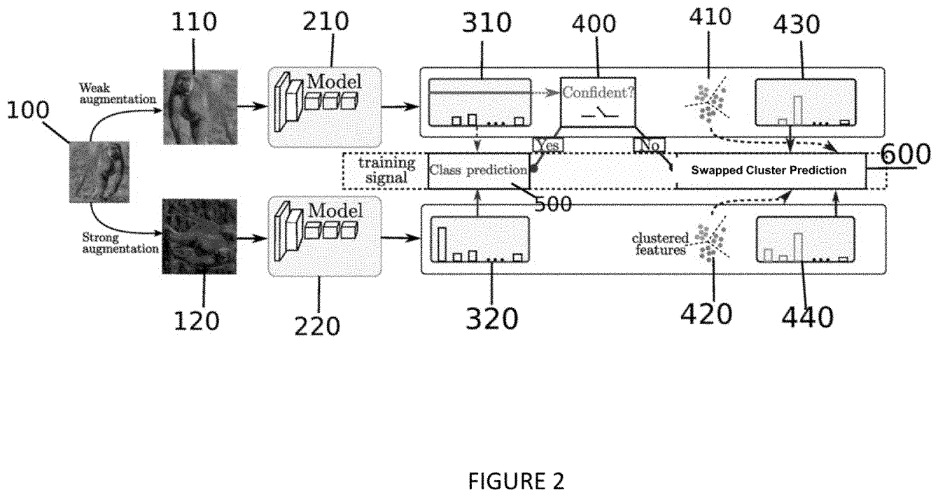

The described method and system effectively combines self-supervised and semi-supervised strategies in a unified formulation. The process uses a self-supervision signal only in cases where no pseudo-label can be assigned with high confidence. FIG. 2 illustrates an overview of this approach.

Specifically, as illustrated in FIG. 2, a SwAV (Swapping Assignments Between Views) approach is used to train a model. SwAV is a self-supervised learning approach that takes advantage of contrastive methods without requiring the computing of pairwise comparisons. Specifically, it simultaneously clusters the data while enforcing consistency between cluster assignments produced for different augmentations (or views) of the same image, instead of comparing features directly as in contrastive learning. The SwAV uses a swapped prediction mechanism where the cluster assignment of a view is predicted from the representation of another view.

As illustrated in FIG. 2, an unlabeled image 100 is used to create two augmented versions of the unlabeled image 100, a weak augmentation image version 110 and a strong augmentation image version 120. The weak augmentation image version 110 is fed into deep convolutional network 210 that takes the weakly augmented version of the image 110 as input and outputs a class prediction. The predictions are fed into a model 310 that assigns a probability (confidence level) to the class prediction that is above a predetermined threshold and outputs a confidence level for that class prediction of the weak augmentation image version 110 to a confidence evaluator 400, which evaluates the confidence of the class prediction receives from the model 310, and outputs the class prediction of the weak augmentation image version 110 to a loss determinator 500.

The strong augmentation image version 120 is fed into deep convolutional network 220 that takes the strongly augmented version of the image 120 as input and outputs a class prediction.

The predictions are fed into a model 320 that assigns a probability (confidence level) to the class prediction that is above a predetermined threshold and outputs that class prediction of the strong augmentation image version 120 to the loss determinator 500.

If the confidence evaluator 400 determines the class prediction from the model 310 is confident, the class prediction of the weak augmentation image version 110 is used as a target by the loss determinator 500 to compute a loss between the class prediction of the weak augmentation image version 110 and the class prediction of the strong augmentation image version 120.

The weak augmentation image version 110 is also processed, by a target cluster assignment network 410, wherein the features of the penultimate layer of the network are clustered in an on-line fashion to assign the weak augmentation image version 110 to a cluster.

The strong augmentation image version 120 is also processed, by a target cluster assignment network 420, wherein the features of the penultimate layer of the network are clustered in an on-line fashion to assign the strong augmentation image version 120 to a cluster.

A cluster assignment prediction network 430 determines a cluster assignment prediction of the weak augmentation image version 110, and a cluster assignment prediction network 440 determines a cluster assignment prediction of the strong augmentation image version 120.

If the confidence evaluator 400 determines the class prediction from the model 310 is not confident, a training network 600 uses the cluster labels are used as targets for training the model.

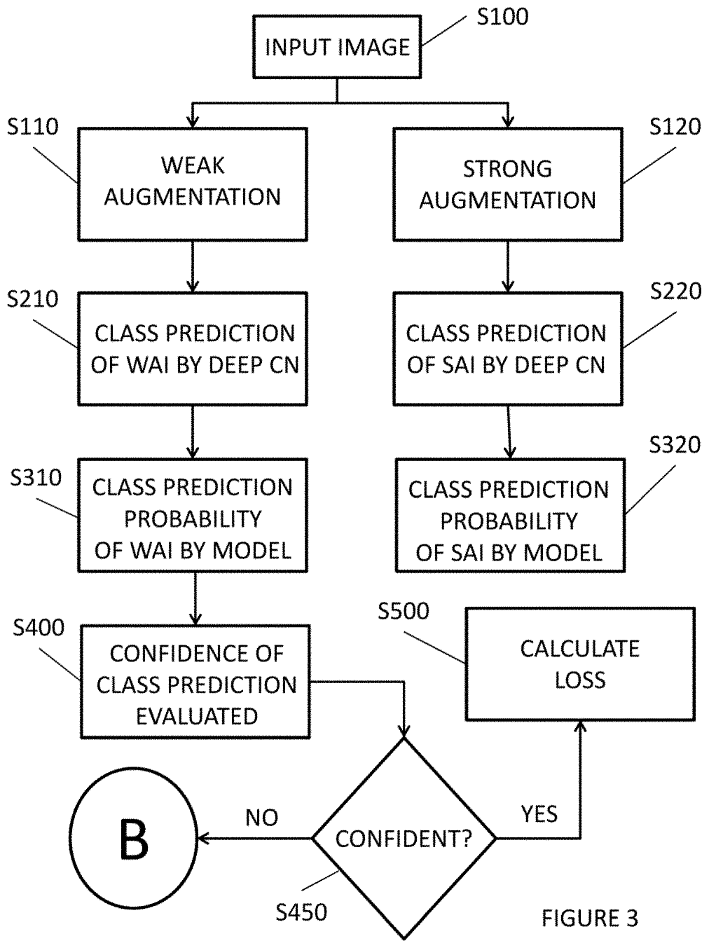

FIGS. 3 and 4 illustrate a flowchart showing an example of a method of learning/training a model using combine self-supervised and semi-supervised strategies. As illustrated in FIG. 3, at step S100, an image is inputted. At step S110, a weak augmentation is applied to the image, which distorts the image only a little At step S120, a strong augmentation is applied to the image, which distorts the image a lot.

At Step S210, a deep convolutional network takes the weakly augmented version of the image as input and outputs a class prediction. At step S220, a deep convolutional network takes the strongly augmented version of the image as input and outputs a class prediction. At step S310, a probability (confidence level) is assigned to the class prediction of the weakly augmented version of the image that is above a predetermined threshold.

At step S320, a probability (confidence level) is assigned to the class prediction of the strongly augmented version of the image that is above a predetermined threshold.

As step S400, the confidence of the class prediction of the weakly augmented version of the image is evaluated. At step S450, it is determined if the confidence of the class prediction of the weakly augmented version of the image is confident.

If step S450 determines that the confidence of the class prediction of the weakly augmented version of the image is confident, step S500 uses the class prediction of the weakly augmented version of the image as target to compute a loss between the class prediction of the weakly augmented version of the image and the class prediction of the strongly augmented version of the image.

At step S410, the features of the penultimate layer of the network are clustered in an on-line fashion to assign the weakly augmented image to a cluster. At step S420, the features of the penultimate layer of the network are clustered in an on-line fashion to assign the strongly augmented image to a cluster.

At step S430, a cluster assignment prediction is made for the weakly augmented image, and at step S440, a cluster assignment prediction is made for the strongly augmented image.

If step S450 determines that the confidence of the class prediction of the weakly augmented version of the image is not confident, the cluster labels are used as targets for training the model, at step S600.

As illustrated in FIGS. 2-4, the learning considers a deep clustering of the features and enforce consistency between predicted cluster assignments for the two augmented versions of a same image.

This algorithmic change leads to an empirical benefit for barely-supervised learning, owing to the fact that training signal is available even when no pseudo-label is assigned.

Additionally, the learning may include two strategies to refine the pseudo-label selection: (a) by leveraging the history of the model prediction per sample and (b) by imposing constraints on the ratio of pseudo-labeled samples per class. The combination of these additional strategies is called label-efficient semi-supervision (“LESS”).

The data, discussed below, demonstrates benefits from using LESS on the STL-10 dataset in barely supervised settings. For instance, average test accuracy increases from 35.8% to 64.2% when considering 4 labeled images per class, compared to FixMatch.

Self-training is a method for semi-supervised learning where model predictions are used to provide training signal for unlabeled data. In particular, pseudo-labeling generates artificial labels in the form of hard assignments, typically when a given measure of model confidence, such as the peakyness of the predicted probability distribution, is above a certain threshold. It is noted that this results in the absence of training signal when no confident prediction can be made.

Consistency regularization is based on the assumption that model predictions should not be sensitive to perturbations applied on the input samples. Several predictions are considered for a given data sample, for instance, using multiple augmentations or different versions of the trained model. Artificial targets are then provided by enforcing consistency across these different outputs. This objective can be used as a regularizer, computed on the unlabeled data along with a supervised objective.

ReMixMatch and Unsupervised Data Augmentation (“UDA”) have used model predictions on weakly-augmented version of an image to generate artificial target probability distributions. These distributions are then sharpened and used as supervision for a strongly-augmented version of the same image. FixMatch provides a simplified version where pseudo-labeling is used instead of distribution sharpening, without the need for additional tricks, such as distribution alignment or augmentation anchoring; i.e., using more than one weak and one strong augmented version; from ReMix-Match or training signal annealing from UDA.

The present method, as illustrated in FIG. 2, extends FixMatch by leveraging a self-supervised loss in cases where the pseudo-label is unconfident, allowing to perform barely-supervised learning in realistic settings.

Early self-supervised learning was based on the idea that a network could learn important image features and semantic representation of the scenes when trained to predict basic transformations applied to the input data, such as a simple rotation in Rot-Net or solving a jigsaw puzzle of an image; i.e., recovering the original position of the different pieces.

More recently, self-supervised learning has used contrastive learning, to the point of outperforming supervised pretraining for tasks such as object detection, at least when performing the self-supervision on object-centric datasets such as Imagenet. The main idea consists in learning feature invariance to class-preserving augmentations. More precisely, each batch contains multiple augmentations of a set of images and the network should output features that are close for variants of a same image and far from those from the other images. In other words, it corresponds to learning instance discrimination, and is closely related to consistency regularization

The present method, as illustrated in FIGS. 2-4, leverages SwAV which slightly relaxes the feature invariance principle by learning to predict cluster assignments; i.e., encouraging features of different augmentations of an image to be assigned to a same cluster, but not necessarily to be exactly similar.

In SelfMatch, a semi-supervised method (FixMatch) is applied starting from a model pretrained with self-supervision using SimCLR. Similarly, CoMatch shows that using such a model for initialization performs slightly better than using a randomly initialized network

The present method departs from the sequential approach of doing self-supervision followed by semi-supervision, with a tighter connection between the two concepts, to improve performance.

In another conventional approach, self-supervision is first applied, and then a classifier is learned on the labeled samples only, which is used to assign a pseudo-label to each unlabeled sample. These pseudo-labels are finally used for training a classifier on all samples. While effective on ImageNet with 1% of the training data, this conventional approach still represents about 13,000 labeled samples, and may generalize less when considering a lower number of labeled examples

S4L uses a multi-task loss where a self-supervised loss is applied to all samples while a supervised loss is additionally applied to labeled samples only. Similarly, the classifier is only learned on the labeled samples, a scenario which would fail in the regime of bare supervision where very few labeled samples are considered.

To better understand the present method, FixMatch will be explained in more detail and analyzed with respect to the dilemma between exploration vs. pseudo-label accuracy.

With respect to FixMatch, let S={(xᵢ,yᵢ)} i=1, . . . Mₛ be a set of labeled data, sampled from P_{x,y}. In fully-supervised training, the end goal is to learn the optimal parameter θ* for a model p_{θ}, trained to maximize the log-likelihood of predicting the correct ground-truth target, p_{θ}(y|x), given the input x:

$${θ}^{*} = {argmax}_{θ} {𝔼}_{( x , y ) ∼ {P}_{x , y}} [ log {p}_{θ} ( y \vert x ) ] . \qquad ( 1 )$$

In semi-supervised learning, an additional set U={(xⱼ)} j=1, . . . Mᵤ of unlabeled: i.e., where the label y is not observed, can be leveraged.

Self-training exploits unlabeled data points by using model outputs as targets. Specifically, class predictions with enough probability mass (over a threshold τ) are considered confident and converted to one-hot targets, called pseudo-labels. Denoting the stop-gradient operator f̅ and ŷₓ=argmax(p̅_{θ}(x)), the self-training objective can be written:

$${maximize}_{θ} {𝔼}_{x ∼ {P}_{x}} [ {𝕝}_{\{ . \geq τ \}} ( max {\overline{p}}_{θ} ( x ) ) \cdot log {p}_{θ} ( {\hat{y}}_{x} \vert x ) ] . \qquad ( 2 )$$

Ideally, labels should progressively propagate to all x∈U.

Consistency regularization is another paradigm which assumes a family of data augmentations A that leaves the model target unchanged. Denote by f_{θ}(x), a feature vector, possibly different from p_{θ}; e.g., produced by an intermediate layer of the network. The features produced for two augmentations of the same image are optimized to be similar, as measured by some function D. Let (v, w)∈A² and denote xᵥ=v(x), the objective can be written:

$${minimize}_{θ} {𝔼}_{x ∼ {P}_{x} , ( v , w ) ∼ {A}^{2}} [ {f}_{θ} ( {x}_{v} ) , {f}_{θ} ( {x}_{w} ) ] . \qquad ( 3 )$$

This problem admits constant functions as trivial solutions; numerous methods exist to ensure that relevant information is retained while learning invariances.

In the FixMatch algorithm, self-training and consistency-regularization coalesce in a single training loss. Weak augmentations w˜A_{weak} are applied to unlabeled images, and confident predictions are kept as pseudo-labels and compared with model predictions on a strongly augmented variant of the image, using s˜A_{strong}:

[symbol]

_{distill}^{θ}(x_{w},xₛ)= [symbol] _{{·≥T}}(max p̅_{θ}(x_{w}))·log p_{θ}(ŷₓ_{_{w}}|xₛ) (4)

The FixMatch algorithm has proved successful in learning an image classifier with bare supervision on CIFAR-10. As will be discussed below, it is not straightforward to replicate such performance on more challenging datasets such as STL-10.

With respect to FixMatch, assume model p_{θ}is trained with the loss in above Equation 4, and consider the event E_{θ}(τ) defined as: the model p_{θ}confidently making an erroneous prediction on x with confidence threshold τ, then P(E_{θ}(x, τ)) is equal to:

$${𝔼}_{w ∼ {A}_{weak}} [ {𝕝}_{\{ . \geq τ \}} ( max {\overline{p}}_{θ} ( {x}_{w} ) ) \cdot {𝕝}_{\{ . \neq y \}} ( argmax {\overline{p}}_{θ} ( {x}_{w} ) ) ] . \qquad ( 5 )$$

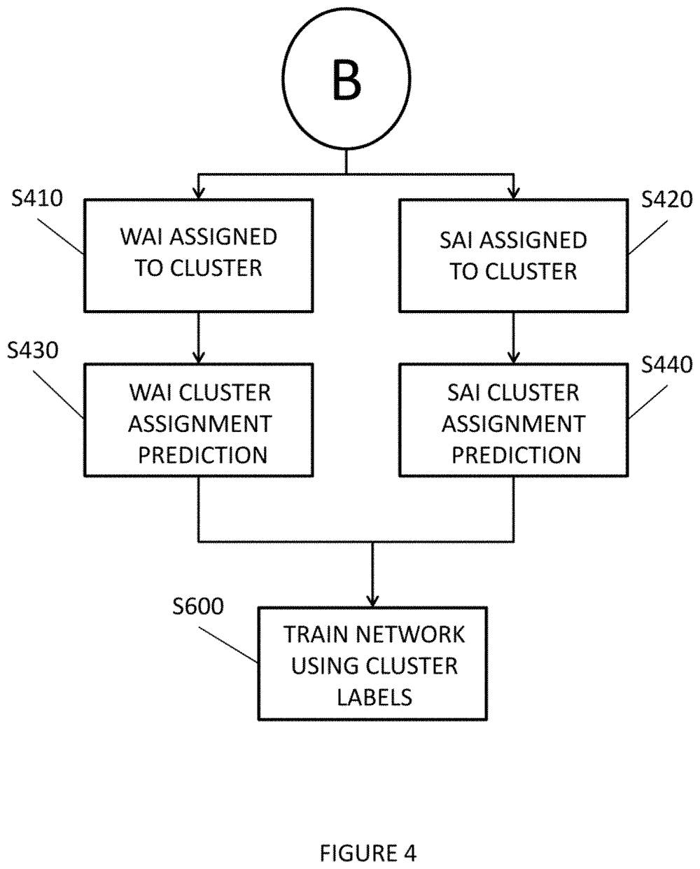

For fixed model parameters θ, P(E_{θ}(x,τ)) is monotonously decreasing in τ. Denote θ(t) the model parameters at iteration t; if the event E_{θ(t)}(x, τ) occurs at time t, by definition optimizing Equation 4 leads in expectation to P(E_{θ(t+1)}(x, τ))>P(E_{θ(t)}(x, τ)). Thus, the model becomes more likely to make the same mistake. Once the erroneous label is accepted, it can propagate to data points similar to x, as happens with ground truth targets. This is referred to as error drift or confirmation bias. This issue is highlighted by plot (A) of FIG. 5, where the ratio of correct and confident pseudo-label drop at some point when too many incorrect pseudo-labels were used in previous iterations.

FIG. 5 illustrates the distillation dilemma of FixMatch when training on STL-10 with 40 labels during the first 50 epochs. For three different values of the confidence threshold τ (0.95, 0.98 and 0.995—(A), (B), and (C) respectively), FIG. 5 shows the ratio of images with a correct and confident pseudo-label (area below line 710), with an incorrect but confident pseudo-label (area between lines 710 and 700) and with unconfident pseudo-label (area above line 700) for which no training signal is used. A large value of τ leads to too few images having a pseudo-label. A lower value allows leveraging of more images, but many pseudo-labels are wrong, which is emphasized in later iterations (highlighted in (A) between lines 710 and 700 for τ=0.95).

With respect to signal scarcity, Let r_{θ}(τ) be the expected proportion of points that do not receive a pseudo-label when using Equation 4:

$${r}_{θ} ( τ ) = {𝔼}_{x ∼ {P}_{x}} [ {𝕝}_{\{ . \geq τ \}} ( max {\overline{p}}_{θ} ( x ) ) ] . \qquad ( 6 )$$

For fixed model parameters θ, r_{θ}(τ) is monotonously increasing in τ. With few ground-truth labels, most unlabeled images will be too dissimilar to all labeled ones to obtain confident pseudo-labels early in training. Thus for high values of τ, r_{θ}(τ) will be close to 1 and most data points masked by [symbol] {·≥T} in Equation 4, thus providing no gradient. The network receives scarce training signal; in the worst cases, training will never start, or plateau early. This is referred to as signal scarcity, which is illustrated in plot (C) of FIG. 5 where the ratio of images with confident pseudo-label remains low, meaning that many unlabeled images are actually not used during training.

The success of the FixMatch algorithm hinges on its ability to navigate the pitfalls of error drift and signal scarcity. Erroneous predictions, as measured by P(E_{θ}(x,τ)), are avoided by increasing the hyper-parameter τ. Thus, the set of values that avoid error drift can be assumed to be of the form ∇=[T_{d}, 1] for some τd∈[0, 1].

Conversely avoiding signal scarcity, as measured by r_{θ}(τ), requires reducing τ, and the set of admissible values can be assumed of the form Δ=[0, τₛ] for some τₛ∈[0, 1]. Successful training with Equation 4 requires the existence of a suitable value of τ; i.e., Δ∩∇≠∅, and that this τ can be found in practice.

On CIFAR-10 strikingly low amounts of labels are needed to achieve that. However, as shown in FIG. 5, it is not the case on more challenging datasets such as STL-10.

In FixMatch, the absence of confident pseudo-labels leads to the absence of training signal, which is at odds with the purpose of consistency regularization—to allow training in the absence of supervision signal—and leads to the distillation dilemma.

The present method instead decouples self-training and consistency-regularization, by using a self-supervision in case no confident pseudo-label has been assigned. While still relying on consistency regularization, the self-supervision does not depend at all on the labels or the classes, thus it differs from conventional approaches which use consistency regularization depending on the predicted class distribution of the weak augmentation to train the strong augmentation.

To ease notations in what follows, let:

[symbol]

_{{·≥T}}:(a, b)→ [symbol] _{{·≥T}}(p)·a+ [symbol] _{{·<T}}(p)·b (7)

Intuitively, [symbol] _{{·≥T}}^{p} selects the first of two inputs if p>τ, the second otherwise. Some loss [symbol] _{self} is relied upon to provide training signal when Equation 4 does not, yielding:

[symbol]

ₒᵤᵣₛ^{θ}(x_{w}, xₛ)= [symbol] _{{·≥T}}^{max p}^{_{θ}}^{(x}^{ᵤ}⁾( [symbol] _{distill}^{θ}, [symbol] _{self}^{θ})(x_{w}, xₛ) (8)

By design, the gradients of this loss are never masked. Thus, in settings with hard data and scarce labels, it is possible to use a very high value for τ, to avoid error-drift, without wasting computations. In practice at each batch, images are sampled from S and U, transformations from A_{weak}, A_{strong} are used, and Equation 9 is minimized:

$${\sum }_{{x}_{i} ∈ S} - log {p}_{θ} ( y \vert {w}_{i} ( {x}_{i} ) ) + {\sum }_{{x}_{j} ∈ 𝒰} {ℒ}_{dense}^{θ} ( {w}_{j} ( {x}_{j} ) , {s}_{j} ( {x}_{j} ) ) . \qquad ( 9 )$$

For the self-supervised loss, L_{self} deep-clustering is leveraged by applying clustering methods to the images projected in a deep feature space, using k-means after each epoch, or online with the Sinkhorn-Knopp algorithm. This method does not require extremely large batch sizes, storing a queue, or an exponential moving average model for training. Denote qₐ a possibly soft cluster assignment operator over k classes, used as target for model predictions q_{θ}. To implement consistency-regularization, the assignment qₐ(xᵤ) of an augmentation xᵤ is predicted from another augmentation xᵥ and vice-versa:

$${clust}_{θ}^{} ( {x}_{u} , {x}_{v} ) = {\sum }_{i = 1}^{k} {q}_{a}^{i} ( {x}_{u} ) log {q}_{θ}^{i} ( {x}_{v} ) + {q}_{a}^{i} ( {x}_{v} ) log {q}_{θ}^{i} ( {x}_{u} ) . \qquad ( 10 )$$

If qₐ ensures that all clusters are well represented the problem cannot be solved by trivial constant solutions. As illustrated in FIG. 2, the pseudo-label is used on the strong augmentation if confident, and a self-supervised loss based on deep clustering is used otherwise.

With respect to self-supervised pre-training, an alternative to leverage self-supervision is to use a self-then-semi paradigm; i.e., to first pretrain the network using unlabeled consistency regularization, then continue training using FixMatch.

It is beneficial to optimize both simultaneously rather than sequentially. Self-supervision yields representations that are not tuned to a specific task. Leveraging the information contained in ground-truth and pseudo-labels is expected to produce representations more aligned with the final task, which in turn can lead to better pseudo-labels. Empirically, self-supervised models transfer quickly but yield over-confident predictions after a few epochs, and thus suffer from strong error drift.

Two methods will be described to refine pseudo-labels beyond thresholding softmax outputs with a constant τ.

With respect to avoiding errors by estimating consistency, as p_{θ}(x) is used as a measure of confidence, the mass allocated to the class c should ideally be equal to the probability of it being correct. Such a model is called calibrated, formally defined as:

P(arg max p_{θ}(x)=y)=p_{θ}^{y}(x) (11)

Unfortunately, deep models are notoriously hard to calibrate and strongly lean towards over-confidence, which degrades pseudo-labels confidence estimates. At training time, augmentations come into play; let [symbol] _{x,θ}^{c} the set of transformations for which x is classified as c:

[symbol]

_{x,θ}^{c}={u∈ [symbol] |arg max p_{θ}(xᵤ)=c} (12)

The probability of x being well classified by p_{θ}is the measure: μ( [symbol] _{x,θ}^{y}) with y the true label. For unlabeled images, this accuracy cannot be estimated empirically as y is unknown. Instead prediction consistency is used as a proxy: wherein it is assumed that the most predicted class y\hat{ } is correct and seek to estimate μ( [symbol] _{x,θ}^{ŷ}). Empirically, testing the hypothesis:

h:‘(μ( [symbol] _{x,θ}^{ŷ})≥λ)’ with confidence threshold α,

is interesting.

Note for any class, c, (μ( [symbol] _{x,θ}^{c})≥0.5) implies ŷ=c. Hypothesis h can be tested with a Bernoulli parametric test: let \hat{μ}_{x,θ}^{c} be the empirical estimate of μ( [symbol] _{x,θ}^{c}). The point of interest is where \hat{μ}_{x,θ}^{c} is close to 1. So, assuming the N≥30, [\hat{μ}_{x,θ}^{c}−3/N; 1] is approximately a 95% confidence interval.

The cost of the test is amortized by accumulating a history of predictions for x, of length N, at different iterations. Thus, there is a trade-off between how stale the predictions are and the number of trials. At the end of each epoch, data points that pass the approximate test for h are added to the labeled set, for the next epoch.

With respect to class-aware confidence threshold, the optimal value for the confidence threshold τ in Equation 8 depends on the model prediction accuracy. In particular, different values for τ can be optimal for different classes and at different times. Classes that rarely receive pseudo-labels may benefit from more ‘curiosity’ with a lower τ, while classes receiving a lot of high quality labels may benefit from being conservative, with a higher τ.

To go beyond a constant value of τ shared across classes, it is assumed that an estimate r_{c} of the proportion of images in class c, is available and estimate p_{c} the proportion of images confidently labeled into class c by the model. At each iteration, the following updates are performed:

p_{c}^{t+1}=αp_{c}^{t}+(1−α)p_{c}^{batch} (13)

T_{c}^{t+1}=T_{c}^{t}+ϵ·sign(p_{c}−r_{c}) (14)

Equation 14 decreases τ_{c} for classes that receive less labels than expected, allowing more exploration for more uncertain labels. Conversely, the model can focus on the most certain images for classes that are well represented. This procedure introduces two hyper-parameters (αand ϵ), but these only impact how fast τ and p_{c} are updated. In practice, Equations 13 and 14 do not need to be tuned, and reasonable default values of α=0.9 and ϵ=0.001 are used

The STL-10 dataset consists of 5,000 labeled images of resolution 96×96 split into 10 classes, and 100,000 unlabeled images. It contains images with significantly more variety and detail than images in the CIFAR datasets. STL-10 is extracted from ImageNet, and images in the unlabeled set can be very different from those in the labeled set. It also remains manageable in terms of size, with twice as many images as in CIFAR-10, offering an interesting trade-off between challenge and computational resources required. Various amounts of labeled data are used: 10 (1 image per class), 20, 40, 80, 250, 1000, and Wide-ResNet-37-2 architecture is used.

CIFAR-10 and CIFAR-100 both contain 60,000 labeled images, split into 50,000 train images and 10,000 validation images, from 10 and 100 classes respectively. Wide-ResNet-28-2 is used for CIFAR-10 and Wide-ResNet-28-8 for CIFAR-100.

With respect to augmentations, Following FixMatch, weak augmentations are composed of random horizontal image flips, with a probability of 50% and random translations by up to 12.5% vertically and horizontally. For strong augmentations, RandAugment is used, which randomly samples for each image a parameter that controls the magnitude of the applied distortions.

With respect to metrics, the top-1 accuracy is reported for all datasets. In barely-supervised learning, the number of labeled images is small and the choice of which images are labeled can have a large impact on the final accuracy. Thus, the means and standard deviations are reported over multiple runs. Standard deviations increase as the number of labels decreases, so the average across 4 different random seeds is used when using 4 images per class or less, 3 otherwise, and also across the last 10 checkpoints of all runs.

To validate the present method, the baselines and models are trained with progressively smaller sets of labeled images; the main goal being to reach a performance that degrades as gracefully as possible when progressively going towards the barely-supervised regime.

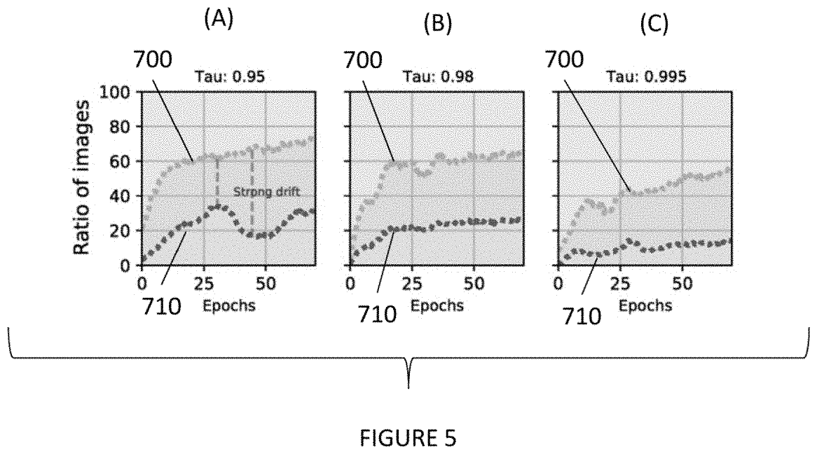

To demonstrate the benefit of the composite loss from Equation 8 (without the proposed pseudo-label quality improvements), first the composite loss from Equation 8 is compared to the original FixMatch loss in FIG. 6 on the STL-10 dataset when training with different sizes of labeled sets, namely {10, 20, 40, 80, 250} labeled images. τ=0.95 is used for FixMatch and τ=0.98 is used for the present method.

The present method (line 720) outperforms FixMatch (line 740), especially in the regime with 40 or 80 labeled images where the test accuracy improves by more than 20%. When more labeled images are considered (e.g. 250), the gain is smaller. When only 1 image per class is labeled, the difference is also small, but the present approach remains the most label efficient.

With respect to FIG. 6, the standard deviations are represented by the dashed lines on either side of lines 720, 730, and 740.

A method using a self-then-semi paradigm is also compared, where SwAV is first applied before FixMatch is run on top of this pretrained model (line 730 of FIG. 6). While it performs better than FixMatch applied from scratch, the present method also outperforms self-then-semi paradigm, in particular in barely-supervised scenario; i.e., with less than 10 images per class.

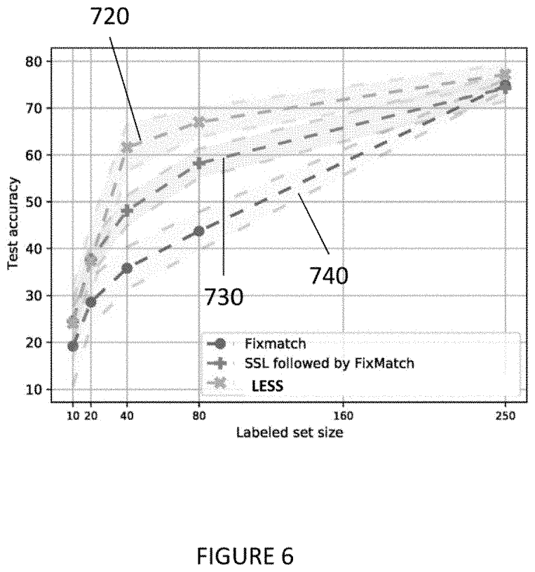

To better analyze these results, FIG. 7 illustrates the evolution of pseudo- label quality for the present method, Fix-Match and SSL-then-FixMatch. For each method (FixMatch (A), present method (B), and SSL-then-FixMatch (C)), FIG. 7 shows the ratio of images that have correct and confident pseudo-labels (area below line 810), incorrect but confident pseudo-labels (area between lines 800 and 810) and unconfident pseudo-labels (area above line 800). FIG. 7 shows the test accuracy with line 820. For SSL-then-FixMatch, as shown in FIG. 7, the early training corresponds to self-supervised learning, thus this information is not available.

As shown in FIG. 7, compared to FixMatch, the present method has less examples with confident pseudo-labels in the early training. The reason is that a higher value of T is set, and the present method does not suffer from signal scarcity due to the self-supervision training signal in case of unconfident pseudo-labels.

In contrast, FixMatch assigns more confident pseudo-labels in early training, at the expense of a higher number of erroneous pseudo-labels, leading eventually to more errors due to error drift, confirmation bias. It is noted that the test accuracy is highly correlated to the ratio of training images with correct pseudo-labels, and thus error drift harms final performance.

When comparing SSL-then-FixMatch to FixMatch, it is observed that the network is quickly able to learn confident predictions, with a lesser ratio of incorrect pseudo-labels. However this ratio is still higher than with the present method that compositely leverages self-supervised and semi-supervised training signal.

When evaluating pre-trained models, model checkpoints obtained between 10 and 20 epochs are used, before more training harms the performance due to confirmation bias. This was cross-validated on a single run using 80 labeled images, and used for all other seeds and labeled sets.

The following discussion will evaluate the present method, as well as the impact of T, with the aim of further increasing pseudo-label quality and improving performance beyond the gains achieved from the composite loss.

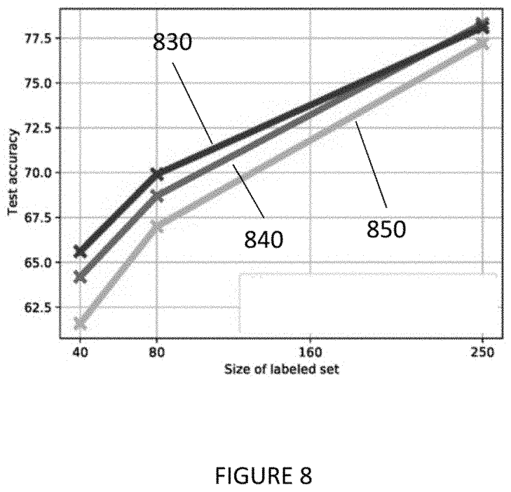

To control the trade-off between quality and amount of pseudo-labels, both for FixMatch and the present method, is to change the confidence threshold. As illustrated in FIG. 9, both methods are trained for values of τ in {0.95, 0.98, 0.995}, with labeled-split sizes in {40, 80}. The first finding is that the average performance of FixMatch degrades when increasing τ; in particular, with 40 labeled images, it drops by 1.9% when increasing τ from 0.95 to 0.98, and by 7.4% when setting τ=0.995. Thus, the default value of τ=0.95 is the best choice, and the improved pseudo-label quality obtained from increasing τ to 0.98 and 0.995 is counterbalanced by signal scarcity.

On the other hand, the performance of the present method improves when increasing τ; in particular, with 40 labeled images, it increases by 2.4%. As expected, the present method benefits from using self-supervised training signal in the absence of confident pseudo-labels, which allows the raising of τ without signal scarcity and without degrading the final accuracy. The performance of the present method remains stable when raising τ to 0.995 and demonstrates that it is robust to high threshold values, even though this does not bring further accuracy improvements. For the rest of the experiments, τ is kept at 0.98 for the present method and τ=0.95 for FixMatch.

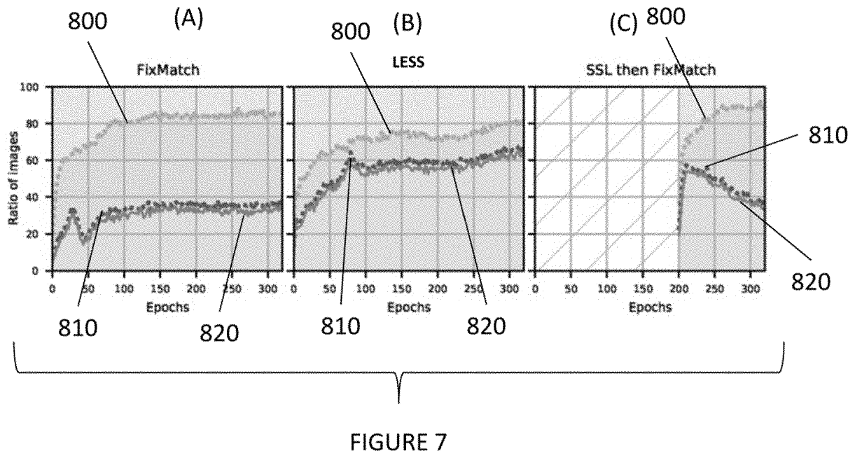

With respect to adaptive threshold and confidence refinement, the usefulness of the class-aware confident threshold is validated. FIG. 8 shows the performance of the present method, with class-aware confident threshold (line 840) and without class-aware confident threshold (line 850)

Adaptive thresholds demonstrate consistent gains across labeled-set sizes; e.g., with an average gain of 2.6% when using 40 labels. This validates the approach of bolstering the exploration of classes that are underrepresented in the model predictions, while focusing on the most confident labels for classes that are well represented. The gains observed are more substantial for low numbers of labeled images, like 40 compared to 250, which suggests that when using a fixed threshold, exploration may naturally be more balanced with more labeled images.

With respect to the impact of using pseudo-label refinement in the present method, the refinement of pseudo-labels is evaluated using a set of predictions for different augmentations u∈A. FIG. 8 shows performance for models trained with Equation 8, with (line 830) and without refined labels (line 840). Using the refined labels offers a 1.4% (resp. 1.1%) accuracy improvement on average when using 40 (resp. 80) labels, on top of the gains already obtained from using composite loss and adaptive thresholds. No improvement is observed, however, with 250 labels.

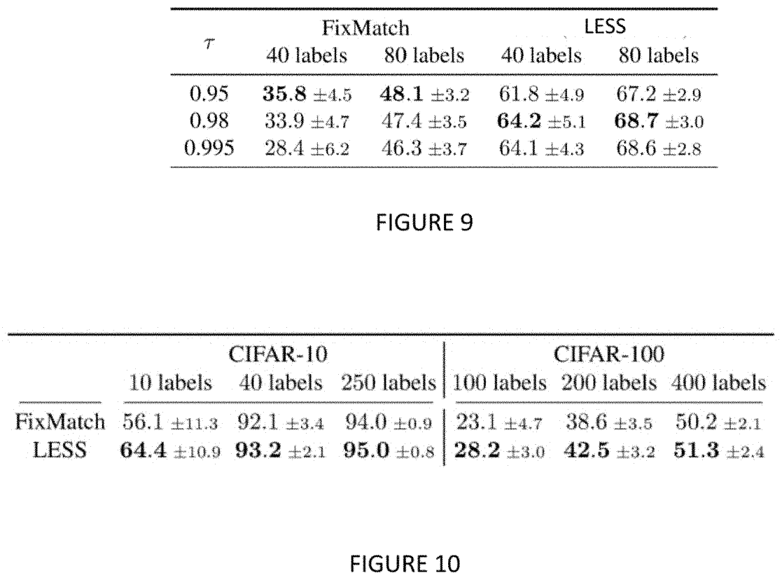

The discussions above only discussed the comparison on the STL-10 dataset. The following discussion will compare the present method with pseudo-labels quality improvements, denoted as LESS for Label-Efficient Semi-Supervised learning, to FixMatch on CIFAR-10 and CIFAR-100 with labeled set sizes of 1, 2 or 4 samples per class. The table in FIG. 10 shows the results of these comparisons.

As shown in FIG. 10, for CIFAR-10, the results for the present method, with τ=0.995, are best among {0.95, 0.98, 0.995}. FIG. 10 also shows that the present method outperforms FixMatch for all cases, with a gain ranging from 5% with 1 label per class to 1% with 4 labels per class on CIFAR-100, and from 8% with 1 label per class to 1% with 25 labels per class on CIFAR-10. The gain here is smaller than STL-10. In other words, as labels becomes more scarce, greater performance gains are observed with the present method.

Moreover, it appears that the very low resolution (32′32) of CIFAR images lead to less powerful self-supervised training signals.

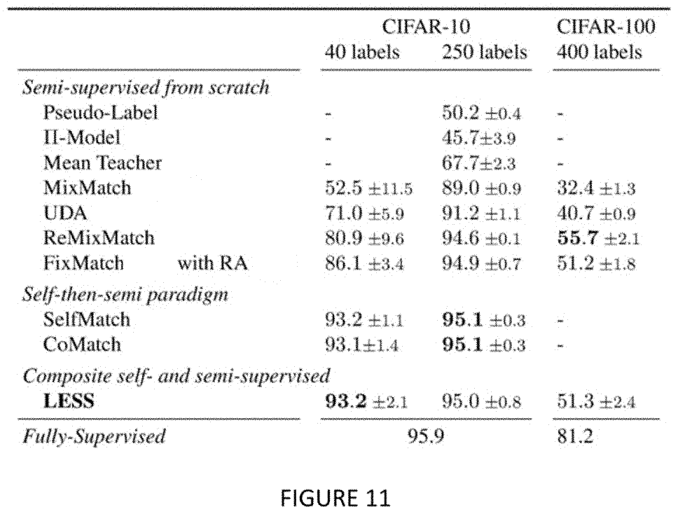

FIG. 11 shows a table comparing the present method to numbers reported in others papers.

It is noted that all previous papers reported numbers on STL-10 with 1000 labels, where the present method does not bring improvements in this regime with such a high number of labeled images per class. Thus, FIG. 11 only provides a comparison on the CIFAR datasets where other methods reported results for smaller numbers of images per class.

As shown in FIG. 11, the present method performs the best on the CIFAR-10 dataset with 4 labels per class and is really close (0.1%) with 25 images per class. On the CIFAR-100 dataset, the present method, LESS, is also close to the other methods with 4 labels per class, with only ReMixMatch being substantially better.

It is noted that distribution alignment, which the present method does not use, brings important gains to ReMix-Match in that setting.

It is further noted that the results shown in FIG. 10 are obtained with code-base, which explains why the slightly lower performance of FixMatch with 40 labels in FIG. 11.

As discussed above, FixMatch in the barely-supervised learning scenario has one critical limitation due to the distillation dilemma. The present method leverages self-supervised training signals when no confident pseudo-label are predicted, thereby enabling significantly increase performance

Additionally, as discussed above, two refinement strategies are utilized to improve pseudo-label quality during training and further increase test accuracy.

The embodiments disclosed above may be implemented as a machine (or system), process (or method), or article of manufacture by using standard programming and/or engineering techniques to produce programming software, firmware, hardware, or any combination thereof. It will be appreciated that the flow diagrams described above are meant to provide an understanding of different possible embodiments. As such, alternative ordering of the steps, performing one or more steps in parallel, and/or performing additional or fewer steps may be done in alternative embodiments.

Any resulting program(s), having computer-readable program code, may be embodied within one or more computer-readable media such as memory devices or transmitting devices, thereby making a computer program product or article of manufacture according to the embodiments. As such, the terms “article of manufacture” and “computer program product” as used herein are intended to encompass a computer program existent (permanently, temporarily, non-transitorily, or transitorily) on any computer-readable medium such as on any memory device or in any transmitting device.

A machine embodying the embodiments may involve one or more processing systems including, but not limited to, CPU, memory/storage devices, communication links, communication/transmitting devices, servers, I/O devices, or any subcomponents or individual parts of one or more processing systems, including software, firmware, hardware, or any combination or subcombination thereof, which embody the embodiments as set forth in the claims.

A method for classifying images to train a deep neural network, comprising: (a) inputting an unlabeled image; (b) electronically generating a weak augmentation version and a strong augmentation version of the inputted image; (c) electronically predicting a class of the weak augmentation version of the inputted image using a deep convolutional network; (d) electronically predicting a class of the strong augmentation version of the inputted image using a deep convolutional network; (e) electronically determining the probability of the predicted classes of the weak augmentation version of the inputted image; (f) electronically determining if the predicted class of the weak augmentation version of the inputted image is confident; (g) electronically using the selected predicted class of the weak augmentation version of the inputted image, if the selected predicted class of the weak augmentation version of the inputted image is determined to be confident, as a target to compute a loss between the predicted class of the weak augmentation version of the inputted image and the predicted class of the strong augmentation version of the inputted image; and (h) electronically using computed loss to train the deep neural network.

The method may further comprise: (i) electronically clustering features of a penultimate layer of the deep neural network, in an on-line fashion, to assign the weak augmentation version of the inputted image to a cluster and to assign the strong augmentation version of the inputted image to a cluster; (j) electronically determining a cluster assignment prediction for the weak augmentation version of the inputted image; (k) electronically determining a cluster assignment prediction for the strong augmentation version of the inputted image; and (I) electronically using cluster labels as targets to train the deep neural network when the selected predicted class of the weak augmentation version of the inputted image is determined to be not confident.

The electronically determining if the predicted class of the weak augmentation version of the inputted image is confident may be determined by

[symbol]

_{{·≥T}}^{p}:(a, b)→ [symbol] _{{·≥T}}(p)·a+ [symbol] _{{·<T}}(p)·b.

The electronically computing a loss between the predicted class of the weak augmentation version of the inputted image and the predicted class of the strong augmentation version of the inputted image may be determined by:

[symbol]

_{distill}^{θ}(x_{w}, xₛ)= [symbol] _{{·≥T}}(max p̅_{θ}(x_{w}))·log p_{θ}(ŷₓ_{_{w}}|xₛ).

The electronically computing a loss between the predicted class of the weak augmentation version of the inputted image and the predicted class of the strong augmentation version of the inputted image may be determined by:

[symbol]

_{distill}^{θ}(x_{w}, xₛ)= [symbol] _{{·≥T}}(max p̅_{θ}(x_{w}))·log p_{θ}(ŷₓ_{_{w}}|xₛ).

The e electronically using cluster labels as targets to train the deep neural network may be realized by:

$${clust}_{θ}^{} ( {x}_{u} , {x}_{v} ) = {\sum }_{i = 1}^{k} {q}_{a}^{i} ( {x}_{u} ) log {q}_{θ}^{i} ( {x}_{v} ) + {q}_{a}^{i} ( {x}_{v} ) log {q}_{θ}^{i} ( {x}_{u} ) .$$

The electronically determining if the predicted class of the weak augmentation version of the inputted image is confident may be determined by

[symbol]

_{{·≥T}}^{p}:(a, b)→ [symbol] _{{·≥T}}(p)·a+ [symbol] _{{·<T}}(p)·b.

The electronically computing a loss between the predicted class of the weak augmentation version of the inputted image and the predicted class of the strong augmentation version of the inputted image may be determined by:

[symbol]

_{distill}^{θ}(x_{w}, xₛ)= [symbol] _{{·≥T}}(max p̅_{θ}(x_{w}))·log p_{θ}(ŷₓ_{_{w}}|xₛ).

The electronically determining if the predicted class of the weak augmentation version of the inputted image is confident may be determined by

[symbol]

_{{·≥T}}^{p}:(a, b)→ [symbol] _{{·≥T}}(p)·a+ [symbol] _{{·<T}}(p)·b.

The electronically computing a loss between the predicted class of the weak augmentation version of the inputted image and the predicted class of the strong augmentation version of the inputted image may be determined by:

[symbol]

_{distill}^{θ}(x_{w}, xₛ)= [symbol] _{{·≥T}}(max p̅_{θ}(x_{w}))·log p_{θ}(ŷₓ_{_{w}}|xₛ).

A system for classifying images to train a deep neural network, comprising: a first deep convolutional network for receiving a weak augmentation image version of an unlabeled image and electronically determining a weak augmentation image class prediction; a second deep convolutional network for receiving a strong augmentation image version of an unlabeled image and electronically determining a strong augmentation image class prediction; a first model for receiving the weak augmentation image class prediction and electronically assigns a confidence level to the weak augmentation image class prediction that is above a predetermined threshold; a confidence evaluator for electronically evaluating the confidence level; a loss determinator electronically using the weak augmentation image class prediction, if the confidence evaluator determines that the confidence level is confident, as a target to compute a loss between the weak augmentation image class prediction and the strong augmentation image class prediction; and a training network using the computed loss to train the deep neural network.

The system may further comprise: a first cluster assignment prediction network to electronically assign the weak augmentation image version of the unlabeled image to a first cluster label; and a second cluster assignment prediction network to electronically assign the strong augmentation image version of the unlabeled image to a second cluster label; the training network electronically using the first and second cluster labels to train the deep neural network.

The confidence evaluator electronically may determine if the predicted class of the weak augmentation version of the inputted image is confident by

[symbol]

_{{·≥T}}^{p}:(a, b)→ [symbol] _{{·≥T}}(p)·a+ [symbol] _{{·<T}}(p)·b.

The loss determinator electronically may compute a loss between the predicted class of the weak augmentation version of the inputted image and the predicted class of the strong augmentation version of the inputted image by:

[symbol]

_{distill}^{θ}(x_{w}, xₛ)= [symbol] _{{·≥T}}(max p̅_{θ}(x_{w}))·log p_{θ}(ŷₓ_{_{w}}|xₛ).

The loss determinator electronically may compute a loss between the predicted class of the weak augmentation version of the inputted image and the predicted class of the strong augmentation version of the inputted image by:

[symbol]

_{distill}^{θ}(x_{w}, xₛ)= [symbol] _{{·≥T}}(max p̅_{θ}(x_{w}))·log p_{θ}(ŷₓ_{_{w}}|xₛ).

The training network electronically may use cluster labels as targets to train the deep neural network by:

$${clust}_{θ}^{} ( {x}_{u} , {x}_{v} ) = {\sum }_{i = 1}^{k} {q}_{a}^{i} ( {x}_{u} ) log {q}_{θ}^{i} ( {x}_{v} ) + {q}_{a}^{i} ( {x}_{v} ) log {q}_{θ}^{i} ( {x}_{u} ) .$$

The confidence evaluator electronically may determine if the predicted class of the weak augmentation version of the inputted image is confident by

[symbol]

_{{·≥T}}^{p}:(a, b)→ [symbol] _{{·≥T}}(p)·a+ [symbol] _{{·<T}}(p)·b.

The loss determinator electronically may compute a loss between the predicted class of the weak augmentation version of the inputted image and the predicted class of the strong augmentation version of the inputted image by:

[symbol]

_{distill}^{θ}(x_{w}, xₛ)= [symbol] _{{·≥T}}(max p̅_{θ}(x_{w}))·log p_{θ}(ŷₓ_{_{w}}|xₛ).

The confidence evaluator electronically may determine if the predicted class of the weak augmentation version of the inputted image is confident by

[symbol]

_{{·≥T}}^{p}:(a, b)→ [symbol] _{{·≥T}}(p)·a+ [symbol] _{{·<T}}(p)·b.

The loss determinator electronically may compute a loss between the predicted class of the weak augmentation version of the inputted image and the predicted class of the strong augmentation version of the inputted image by:

[symbol]

_{distill}^{θ}(x_{w}, xₛ)= [symbol] _{{·≥T}}(max p̅_{θ}(x_{w}))·log p_{θ}(ŷₓ_{_{w}}|xₛ).

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

What is claimed is:

1. A method for classifying images to train a deep neural network, comprising:
(a) inputting an unlabeled image;
(b) electronically generating a weak augmentation version and a strong augmentation version of the inputted image;
(c) electronically predicting a class of the weak augmentation version of the inputted image using a deep convolutional network;
(d) electronically predicting a class of the strong augmentation version of the inputted image using a deep convolutional network;
(e) electronically determining the probability of the predicted classes of the weak augmentation version of the inputted image;
(f) electronically determining if the predicted class of the weak augmentation version of the inputted image is confident;
(g) electronically using the selected predicted class of the weak augmentation version of the inputted image, if the selected predicted class of the weak augmentation version of the inputted image is determined to be confident, as a target to compute a loss between the predicted class of the weak augmentation version of the inputted image and the predicted class of the strong augmentation version of the inputted image; and
(h) electronically using computed loss to train the deep neural network.

2. The method as claimed in claim 1, further comprising:
(i) electronically clustering features of a penultimate layer of the deep neural network, in an on-line fashion, to assign the weak augmentation version of the inputted image to a cluster and to assign the strong augmentation version of the inputted image to a cluster;
(j) electronically determining a cluster assignment prediction for the weak augmentation version of the inputted image;
(k) electronically determining a cluster assignment prediction for the strong augmentation version of the inputted image; and
(I) electronically using cluster labels as targets to train the deep neural network when the selected predicted class of the weak augmentation version of the inputted image is determined to be not confident.

3. The method as claimed in claim 1, wherein said electronically determining if the predicted class of the weak augmentation version of the inputted image is confident is determined by [symbol]
_{{·≥T}}^{p}:(a, b)→ [symbol] _{{·≥T}}(p)·a+ [symbol] _{{·<T}}(p)·b.

4. The method as claimed in claim 1, wherein said electronically computing a loss between the predicted class of the weak augmentation version of the inputted image and the predicted class of the strong augmentation version of the inputted image is determined by: [symbol]
_{distill}^{θ}(x_{w}, xₛ)= [symbol] _{{·≥T}}(max p̅_{θ}(x_{w}))·log p_{θ}(ŷₓ_{_{w}}|xₛ).

5. The method as claimed in claim 4, wherein said electronically computing a loss between the predicted class of the weak augmentation version of the inputted image and the predicted class of the strong augmentation version of the inputted image is determined by: [symbol]
_{distill}^{θ}(x_{w}, xₛ)= [symbol] _{{·≥T}}(max p̅_{θ}(x_{w}))·log p_{θ}(ŷₓ_{_{w}}|xₛ).

6. The method as claimed in claim 2, wherein said electronically using cluster labels as targets to train the deep neural network is realized by:
$${clust}_{θ}^{} ( {x}_{u} , {x}_{v} ) = {\sum }_{i = 1}^{k} {q}_{a}^{i} ( {x}_{u} ) log {q}_{θ}^{i} ( {x}_{v} ) + {q}_{a}^{i} ( {x}_{v} ) log {q}_{θ}^{i} ( {x}_{u} ) .$$

7. The method as claimed in claim 2, wherein said electronically determining if the predicted class of the weak augmentation version of the inputted image is confident is determined by [symbol]
_{{·≥T}}^{p}:(a, b)→ [symbol] _{{·≥T}}(p)·a+ [symbol] _{{·<T}}(p)·b.

8. The method as claimed in claim 2, wherein said electronically computing a loss between the predicted class of the weak augmentation version of the inputted image and the predicted class of the strong augmentation version of the inputted image is determined by: [symbol]
_{distill}^{θ}(x_{w}, xₛ)= [symbol] _{{·≥T}}(max p̅_{θ}(x_{w}))·log p_{θ}(ŷₓ_{_{w}}|xₛ).

9. The method as claimed in claim 5, wherein said electronically determining if the predicted class of the weak augmentation version of the inputted image is confident is determined by [symbol]
_{{·≥T}}^{p}:(a, b)→ [symbol] _{{·≥T}}(p)·a+ [symbol] _{{·<T}}(p)·b.

10. The method as claimed in claim 5, wherein said electronically computing a loss between the predicted class of the weak augmentation version of the inputted image and the predicted class of the strong augmentation version of the inputted image is determined by: [symbol]
_{distill}^{θ}(x_{w}, xₛ)= [symbol] _{{·≥T}}(max p̅_{θ}(x_{w}))·log p_{θ}(ŷₓ_{_{w}}|xₛ).

11. A system for classifying images to train a deep neural network, comprising:
a first deep convolutional network for receiving a weak augmentation image version of an unlabeled image and electronically determining a weak augmentation image class prediction;
a second deep convolutional network for receiving a strong augmentation image version of an unlabeled image and electronically determining a strong augmentation image class prediction;
a first model for receiving said weak augmentation image class prediction and electronically assigns a confidence level to said weak augmentation image class prediction that is above a predetermined threshold;
a confidence evaluator for electronically evaluating said confidence level;
a loss determinator electronically using said weak augmentation image class prediction, if said confidence evaluator determines that said confidence level is confident, as a target to compute a loss between said weak augmentation image class prediction and said strong augmentation image class prediction; and
a training network using said computed loss to train the deep neural network.

12. The system as claimed by claim 11, further comprising:
a first cluster assignment prediction network to electronically assign said weak augmentation image version of the unlabeled image to a first cluster label; and
a second cluster assignment prediction network to electronically assign said strong augmentation image version of the unlabeled image to a second cluster label;
said training network electronically using said first and second cluster labels to train the deep neural network.

13. The system as claimed in claim 11, wherein said confidence evaluator electronically determines if the predicted class of the weak augmentation version of the inputted image is confident by [symbol]
_{{·≥T}}^{p}:(a, b)→ [symbol] _{{·≥T}}(p)·a+ [symbol] _{{·<T}}(p)·b.

14. The system as claimed in claim 11, wherein said loss determinator electronically computes a loss between the predicted class of the weak augmentation version of the inputted image and the predicted class of the strong augmentation version of the inputted image by: [symbol]
_{distill}^{θ}(x_{w}, xₛ)= [symbol] _{{·≥T}}(max p̅_{θ}(x_{w}))·log p_{θ}(ŷₓ_{_{w}}|xₛ).

15. The system as claimed in claim 14, wherein said loss determinator electronically computes a loss between the predicted class of the weak augmentation version of the inputted image and the predicted class of the strong augmentation version of the inputted image by: [symbol]
_{distill}^{θ}(x_{w}, xₛ)= [symbol] _{{·≥T}}(max p̅_{θ}(x_{w}))·log p_{θ}(ŷₓ_{_{w}}|xₛ).

16. The system as claimed in claim 12, wherein said training network electronically uses cluster labels as targets to train the deep neural network by:
$${clust}_{θ}^{} ( {x}_{u} , {x}_{v} ) = {\sum }_{i = 1}^{k} {q}_{a}^{i} ( {x}_{u} ) log {q}_{θ}^{i} ( {x}_{v} ) + {q}_{a}^{i} ( {x}_{v} ) log {q}_{θ}^{i} ( {x}_{u} ) .$$

17. The system as claimed in claim 12 wherein said confidence evaluator electronically determines if the predicted class of the weak augmentation version of the inputted image is confident by [symbol]
_{{·≥T}}^{p}:(a, b)→ [symbol] _{{·≥T}}(p)·a+ [symbol] _{{·<T}}(p)·b.

18. The system as claimed in claim 12, wherein said loss determinator electronically computes a loss between the predicted class of the weak augmentation version of the inputted image and the predicted class of the strong augmentation version of the inputted image by: [symbol]
_{distill}^{θ}(x_{w}, xₛ)= [symbol] _{{·≥T}}(max p̅_{θ}(x_{w}))·log p_{θ}(ŷₓ_{_{w}}|xₛ).

19. The system as claimed in claim 15, wherein said confidence evaluator electronically determines if the predicted class of the weak augmentation version of the inputted image is confident by [symbol]
_{{·≥T}}^{p}:(a, b)→ [symbol] _{{·≥T}}(p)·a+ [symbol] _{{·<T}}(p)·b.

20. The system as claimed in claim 15, wherein said loss determinator electronically computes a loss between the predicted class of the weak augmentation version of the inputted image and the predicted class of the strong augmentation version of the inputted image by: [symbol]
_{distill}^{θ}(x_{w}, xₛ)= [symbol] _{{·≥T}}(max p̅_{θ}(x_{w}))·log p_{θ}(ŷₓ_{_{w}}|xₛ).
